(19) United States
(12) Patent Application Publication
(10) Pub. No.: US 2010/0114614 A1
(43) Pub. Date: May 6, 2010

(54) Controlling Registration for a Social Event

(76) Inventor: Sheldon Sharpe, Brooklyn, NY (US)

Correspondence Address: HARVEY LUNENFELD, 8 PATRICIAN DRIVE, E. NORTHPORT, NY, 11731, US

(21) Appl. No.: 12/266,542

(22) Filed: Nov. 6, 2008

(51) Int. Cl. G06Q 10/00

(52) U.S. Cl. 705/5

(57) ABSTRACT

A system and method for controlling registration for a social event comprising: receiving a request, at a server on a network, from a prospective attendee to register for the social event; determining based upon at least one attribute of the prospective attendee if the number of already registered prospective attendees plus the prospective attendee exceeds a predetermined limit for the at least one attribute, and if so cancelling the prospective attendee's registration; otherwise, determining whether the difference between the number of already registered prospective attendees plus the prospective attendee having the at least one attribute and the number of already registered prospective attendees having at least one other attribute exceeds a predetermined difference limit, wherein: if the difference is less than or equal to the predetermined difference limit, registering the prospective attendee to attend the social event; otherwise, suspending the prospective attendee's registration; notifying the prospective attendee of registration status.

### BACKGROUND OF THE INVENTION

1. Field of the Invention

The present invention relates generally to social events and more particularly to a system and method for controlling registration for and attendance at a social event or social gathering.

2. Background Art

People have been attending social events, gatherings, parties, meetings, conferences, parties, and the like for eons. The right mix of individuals attending such social events and the like can make or break the success of such events, for the individuals attending the events, as well as the individuals managing the events.

Typically, an individual attending such social events and the like desires to meet interesting people, having interesting conversations, promote business, learn new things, network, and establish contact for future social relationships. This is especially true for individuals who are interested in dating one another.

There is often and has been the need for individuals attending social events and the like to meet individuals receptive to their likes and needs, to develop rapport during the meeting process, establish the basis for mutual interest in dating one another socially, and to increase the probability of success for the individuals attending such events, inc accordance with their needs.

One way to enhance success of the individuals attending the events is to control registration for the social events, based upon personal attributes of the individuals. For example, men and women looking to create future social dating opportunities often prefer to have a proportionate number of males and females at the social event, i.e., substantially the same number of men and women at the event, party, or gathering. Other personal attributes may also come into play, such as age, professional interests, hobbies, and so on.

Electronic tools have become available for people to meet one another on the internet. However, meeting one another personally is still, most often the goal of individuals to consummate relationships.

People may use the internet to meet one another. However, means are necessary for these individuals to meet one another in surroundings that enhance success for the individuals. A system and method is necessary that may be used on a distributed network, such as the internet, and comprises a server or computer based application, that facilitates the control of registration for social events, based upon personal attributes of substantially all the individuals who will be attending the event. In particular, the server or computer based application should be capable of controlling the registration and attendance of people who sign up for the event, based upon the sex of the prospective attendees, and create a balanced population of prospective men and women who plan to attend the social event.

Different server and computer based applications have heretofore been known. However, none of the applications adequately satisfies these aforementioned needs.
U.S. Pat. No. 7,255,277 (Dragos, III) discloses a system and method for designating dating status, which proposes to limit the embarrassment of rejection and minimize cost of implementation, based upon market recognition of an external sign to be associated with dating status, such as a color-coded bracelet.
U.S. Pat. No. 7,246,067 (Austin, et al.) discloses a secure online dating support system and method that requires potential members to submit personal information regarding themselves as a predicate to becoming a member of the dating system. The personal information is provided in a manner, either in-person at an information receiving center, or submitted to an information collector, or submitted directly to an online dating service that permits its verification. Preferably, authorization is also provided by the potential member for further investigation, resulting in an investigator conducting an investigation, and communicating the results to the online dating service, so that the information revealed by the investigation can be displayed to members of the online dating service and/or to individuals outside of the dating service who have been given access by the participating member.
U.S. Pat. No. 7,188,153 (Lunt, et al.) discloses a system and method for managing connections in an online social network, in which the online social network collects descriptive data about various individuals and allows those individuals to indicate other individuals with whom they have a personal relationship. The descriptive data and the relationship data are integrated and processed to reveal the series of social relationships connecting any two individuals within a social network. A maximum degree of separation setting is provided and set to at least two. The maximum degree of separation setting limits the amount of searching that is carried out, when searching for a connection between two individuals in the social network.
U.S. Pat. No. 7,117,254 (Lunt, et al.) discloses a method of inducing content uploads in a social network or online network, which includes the steps of storing content relating to a first member of the network that is submitted by a second member of the network, receiving approval of the content from the first member, and associating the content with the first member. The uploaded content may comprise an image file containing a photo of the first member and a caption associated with the photo image. The second user uploads the content relating to the first member using a GUI. This GUI is made available to the second user through a hyperlink that appears when a profile page of the first member is accessed if the degree of separation between the first member and the second member is less than or equal to a maximum degree of separation set by the first user. On the other hand, the hyperlink to this GUI will not appear when the profile page of the first member is accessed by the second member if the degree of separation between the first member and the second member is greater than the maximum degree of separation set by the first user. The default setting for this maximum degree of separation is one.
U.S. Pat. No. 7,085,806 (Shapira) discloses a method and apparatus for recommending a match to another individual, that provides individuals a way to take an active role in matchmaking between a friend, family member or client of theirs and a prospect date from a database of prospect-users. For example, users may be provided with the ability to review a repository of users who have registered with a dating service (referred to as prospect-users) in order to search for a person who may be compatible with a friend or associate of the user performing the search (referred to as a searching-user). If the searching-user locates a prospect-user whom the searching-user thinks may be of interest to the searching-user's friend or associate (referred to as a client-user), the searching-user may recommend that person to the prospect-user. Thus, the invention provides a way to transmit a recommendation message to the prospect-user via a communication conduit such as a computer network. After viewing an associated profile of the client-user, the prospect-user may respond to the recommendation message by sending a response message to the client-user. The client-user may then view a profile of the prospect-user and elect to reply to the prospect-user's response message. If all of the parties involved indicate a willingness to meet, the system provides a way for the parties to contact one another.
U.S. Pat. No. 7,069,308 (Abrams) discloses a system, method and apparatus for connecting users of an online computer system, based on their relationships within social networks, which includes calculating, displaying, and acting upon relationships in a social network. A computer system collects descriptive data about various individuals, and allows those individuals to indicate other individuals with whom they have a personal relationship. The descriptive data and the relationship data are integrated and processed to reveal the series of social relationships connecting any two individuals within a social network. The pathways connecting any two individuals can be displayed. Further, the social network itself can be displayed to any number of degrees of separation. A user of the system can determine the optimal relationship path (i.e., contact pathway) to reach desired individuals. A communications tool allows individuals in the system to be introduced (or introduce themselves) and initiate direct communication.
U.S. Pat. No. 6,896,263 (Matthews) discloses a game for teaching fundamental dating lessons and dating skills that includes a first deck containing a plurality of cards, the cards in the first deck having a face containing information representing a character trait, which may be valuable when dating, and a second deck containing a plurality of cards, the cards in the second deck having a face containing information representing a dating challenge and information representing at least one resolution to the dating challenge. The decks of cards are used in combination with a playing surface displaying at least one track, containing spaces corresponding to both decks of cards.
U.S. Pat. No. 6,735,568 (Buckwalter, et al.) discloses a method and system for identifying people who are likely to have a successful relationship. Functions and operations of a matching service are disclosed that includes approximating the satisfaction that a user of the matching service has in the relationships that the user forms with others, and identifying candidates for a relationship with the user based on the approximated satisfaction. The method and system also includes approximating the satisfaction that the user will have in a relationship with a particular candidate. The matching service identifies two parties for a relationship. The matching service also makes a plurality of communication levels available at which the parties can communicate. Each communication level allows the parties to exchange information in a different format. The parties are permitted to exchange information at one of the communication levels.
U.S. Pat. No. 6,665,389 (Haste, III) discloses an interactive internet-based dating service that allows people to anonymously interact via Internet browsers, telephone communications, and/or video conferencing. The system employs an interactive web site, allowing a person to seek another person who may be compatible for a relationship. The system gives the member the option to allow other members to make contact via email, telephone, or video conferencing. All communications through the system are anonymous, in that the searcher is never provided the member's actual email address or phone number. Each member can choose to block access to his or her personal information by other members, based on selection criteria, and can likewise block access to the member's email, phone, or video conferencing service.
U.S. Pat. No. 6,594,502 (Koester) discloses a dating system or dating service that allows potential dates to observe the users of the system in their automobiles. A preview of the person allows them to decide if they are compatible in age, attractiveness, and economic level. The potential date could then call a telephone service to hear a brief message about the person's interests and information, after entering the automobile's license plate number. A voice message can then be left for the user of the system for anonymous contact.
U.S. Pat. No. 6,385,620 (Kurzius, et al.) discloses a system and method for management of candidate recruiting information, and, in particular, a system for automated candidate recruiting, using a network that includes a candidate web engine operable to communicate with the network and to present a candidate survey form to a client of the network, the candidate web engine further operable to receive candidate qualification data from the client that is entered in the form. The system further includes a candidate mapping engine in communication with the candidate web engine, the candidate mapping engine operable to receive the candidate qualification data from the candidate web engine and generate at least one candidate identifier in response to parsing the candidate qualification data. The candidate mapping engine is further operable to index the at least one candidate identifier in response to the parsed candidate qualification data. The at least one candidate identifier is linked to a candidate record. The candidate record stores the candidate qualification data.
U.S. Pat. No. 6,061,681 (Collins) discloses an on-line dating service for locating and matching people, based on user-selected search criteria, that includes a computer-implemented system for matching people with each other, which has a main computer server connectable to a network such as the internet; a plurality of local servers connectable to the main computer server via a proprietary network, each of the local servers accessible via a telephone connected to a telephone network; and a database of user information distributed over the main computer server and the local servers. Each of the local servers and the main computer server has means for a particular user to update and read at least a portion of the database, so as to match the particular user with at least one other user of the system. The main computer server provides means to update and read the database via a user computer connected to the internet to access a server page. The local servers provide means to update and read the database via a telephone connected via the telephone network.
U.S. Pat. No. 5,963,951 (Collins) discloses a computerized on-line dating service for searching and matching people, in which a database of subscriber information is searched to find at least one subscriber matching user search criteria. The subscriber information includes preferences of subscribers to the service. Personal preferences for a user are obtained as search criteria. The personal preferences and the subscriber information include at least: a gender preference; a geographic location preference; an age preference; appearance preferences; religious belief preferences; educational level preferences; and a goal preference, and the goal preference is one of “romance”; “friendship” or “a walk on the wild side”, the geographic location preference is at least one of a postal code, a country, a city, a suburb, a block, or a street. The subscriber information includes a date of last payment of a use fee by each subscriber and a date of last updating of a personal profile by each subscriber. The database is repeatedly searched for records matching the personal preferences of the user by at least a percentage match parameter value. The percentage match parameter is reduced by a value of 10%, until at least a required number of matching records are found.
U.S. Pat. No. 5,920,845 (Risemberg) discloses date matching methods that includes a means and method for use at a date matching event to determine, in a discreet manner, the date preferences of a plurality of participants. The method includes gathering the plurality of participants at the date matching event, and assigning a unique identification code to each participant. The identification code is worn or otherwise displayed in plain sight, being readily observable by a plurality of the other participants. Each applicant may next, if time permits, be provided a temporal period to introduce themselves to the other participants, which is followed by a temporal interval for applicants to interact. After an interval for interaction, the date preferences of each participant are discreetly collected and analyzed to determine all occurring mutual matches. The mutual match results are then delivered to the participants, wherein matched participants may then meet to discuss the arrangements for their date.
United States Patent Application 20070069901 (Tuck; Edward F.; et al.) discloses a matching system that includes methods and apparatus for finding a match between or among persons, characteristics, and/or objects. In one embodiment of the invention, an electronic device, such as a handheld radio, is used to find a person who meets criteria specified by a user. In another embodiment, the electronic device is programmed with information regarding the genetic attributes of individuals. These individuals are matched by computing a correlation of the genetic attributes of two individuals. Information regarding the genetic attributes are determined by testing a tissue or fluid sample. In yet another embodiment of the invention, once biological or genetic attributes are determined, a perfume may be manufactured, which is based on a unique set of genetic attributes, and which may either fortify the sexual self-confidence and broadcast the attributes of the person who wears the perfume, or may be used to enhance the attractiveness of another person.
United States Patent Application 20070032240 (Finnegan; Michael Edward; et al.) discloses a real-time, interactive and geographically defined computerized personal matching system and method that includes a system and method of interactive and live computerized matching, in which a first user is provided with a personal data device, including a wireless communication system. A secure network is configured to include a server programmed with a personal characteristic database and a database searching algorithm, and a wireless communication system at a specific geographic location that is capable of communicating with the user's personal data device. The first user is allowed to log on through the wireless communication system to the secure network, using his or her personal data device, and communicate to and store, in the database, personal data defining his or her characteristics and those for his or her ideal match. Either the secure network automatically identifies the first user's precise geographic location, or the user himself otherwise indicates and stores, in the database of the network, an identifying address that indicates his current specific geographic location. The user then instructs the database searching algorithm to search for and identify other users similarly logged on to the network at the same specific geographic location. The user is able to initiate a search of the database for possible matches within the pool of other users also logged on to the network at the same specific geographic location. The secure network then indicates to the first user the results of the search.
United States Patent Application 20050281237 (Heinonen, Tomi; et al.) discloses personal profile sharing and management for short-range wireless terminals, in which a mobile, wireless terminal contains apparatus for creating, editing and storing user personalized profiles for access, by inquiring terminals in a short-range communication system. The mobile, wireless terminal contains databases for storing standardized format profiles containing user contact information, standardized format profiles of user interests and user or manufacturer defined profiles. The personalized profiles are stored in a single record of a service discovery protocol database. Screen display apparatus in the mobile terminal displays indexes and contents of the profiles for user access in creating, editing and storing user profiles. The mobile terminal includes apparatus responsive to the service discovery protocol inquires from inquiring terminals for access to and acquisition of the user defined personalized profiles.
United States Patent Application 20050174975 (Mgrdechian, Richard; et al.) discloses a system and method for wireless communication between previously known and unknown users. In one embodiment, of the invention a wireless communication method, comprising, on a first wireless device, receiving one or more wireless device identifications associated with one or more other wireless devices, and transmitting at least one of the one or more wireless device identifications from the first wireless device to a remote computer system, and on the remote computer system, receiving the at least one wireless device identification, and accessing information associated with the at least one wireless device identification. Embodiments of the present invention may be used for electronic dating, social networking and other communication applications.
United States Patent Application 20040260781 (Shostack, Ronald N.; et al.) and United States Patent Application 20040249811 (Shostack, Ronald N. ; et al.) disclose a web based dating service with weighted interests matching, in which a dating related web site incorporates a number of services of interest to subscribers seeking a compatible mate or friend. A would-be subscriber first specifies profile information including authentication information, information relating to qualities desired in a friend and mate, the relative importance of the respective categories, and a screen image icon. The profile information is stored in a database associated with a web server hosting the dating site. The subscriber can then log onto the site and take advantage of the chat room environments featured at the site. Rooms are hierarchically organized into lobbies and sub-lobbies corresponding to topics and sub-topics of discussion. In addition, the lobby and sub-lobby screens indicate the concentration of compatible participants in the rooms of corresponding lobbies and sub-lobbies, thus allowing easy navigation to a desirable room. In addition to manual navigation, the site features automatic navigation, allowing the user to find a chat room with compatible participants automatically, once a sub-lobby is selected. Upon participating in a chat session, the user and a participant may choose a “virtual date” option featured at the site, to take advantage of a private chat environment, and to view a private, date-related video clip. “Physical Attractiveness” and/or “personality attractiveness” criteria also permit the subscriber to screen members in the database, based upon community ratings of the physical and/or personality attractiveness of the members, and to limit access to the subscriber's profile to members having an attractiveness ranking within a user-selected range around that of the corresponding attractiveness ranking for the subscriber.
United States Patent Application 20040128152 (Austin, Warren; et al.) discloses a secure online dating support system and method that requires potential members to submit personal information regarding themselves as a predicate to becoming a member of the dating system. The personal information is provided in a manner, either in-person at an information receiving center, or submitted to an information collector, or submitted directly to an online dating service that permits its verification. Preferably, authorization is also provided by the potential member for further investigation, resulting in an investigator conducting an investigation, and communicating the results to the online dating service, so that the information revealed by the investigation can be displayed to members of the online dating service and/or to individuals outside of the dating service who have been given access by the participating member.
United States Patent Application 20030233270 (Buss, Charles P.) discloses an apparatus and method for identifying and contacting potential friends and partners that include a mechanism for identifying and contacting potential friends and companions, by placing a program participant identifier printed with identifying indicia in or on a motor vehicle and then correlating at least one piece of information associated with the program participant identifier to identify a specific program participant. In a preferred embodiment of the present invention, the license plate of the vehicle displaying the program participant identifier is the medium for identifying the potential friend or partner.
United States Patent Application 20030191673 (Cohen, Morgan) discloses method and system for connecting and matching users of an electronic dating service, in which, subscribers, or users, of the dating service are connected for a brief duration of time. During that time, the users have a date, or more specifically, a real-time conversation. After the real-time conversation, the users are disconnected from each other and separately asked if they enjoyed the date, or in other words if they felt a mutual attraction, and if they would like to have further contact with each other. If both users respond affirmatively, they are then allowed further contact with each other.

For the foregoing reasons, there is a need for a system and method that may be used on a distributed network, such as the internet, that comprises a server or computer based application and that facilitates the control of registration for social events, based upon personal attributes of substantially all the individuals who will be attending the event. In particular, the server or computer based application should be capable of controlling the registration of people who sign up for the event, based upon the sex of the prospective attendees, and create a balanced population of prospective men and women who plan to attend the social event.

### SUMMARY

The present invention is directed to a system and method that facilitates the control of registration of individuals to attend one or more social events, based upon personal attributes of substantially all the individuals who will be attending the one or more social events. The system and method of the present invention may be used on a distributed network, such as the internet, and may comprise one or more servers and/or one or more computer based applications. In particular, the one or more servers and/or the one or more computer based applications may be used to control the registration of people who sign up for the one or more social events, based upon at least one personal attribute, such as, for example, the sex of prospective attendees, and create a balanced population of, for example, prospective men and women who plan to attend the social event.

A method for controlling registration for a social event having features of the present invention comprises: a) Receiving a request, at a server on a network, from a prospective attendee to register to attend the social event, the request comprising at least one personal attribute data value of the prospective attendee; b) Deciding registration status of the prospective attendee, by the server, comprising: b1) Determining, by the server, whether the number of already registered prospective attendees plus the prospective attendee having the at least one personal attribute data value, will exceed a predetermined limit, wherein: if the number of the already registered prospective attendees plus the prospective attendee having the at least one personal attribute data value is greater than the predetermined limit, then: b2) Cancelling, by the server, registration of the prospective attendee to attend the social event; if the number of the already registered prospective attendees plus the prospective attendee having the at least one personal attribute data value is less than or equal to the predetermined limit, then: b3) Determining, by the server, whether the difference between 1) the number of already registered prospective attendees plus the prospective attendee having the at least one personal attribute data value and 2) at least one other personal attribute data value is less than, equal to, or greater than at least one predetermined difference limit, wherein: if the difference between the number of the already registered prospective attendees plus the prospective attendee having 1) the at least one personal attribute data value and 2) the at least one other personal attribute data value is less than or equal to the at least one predetermined difference limit, then: b4) Registering the prospective attendee, by the server, to attend the social event; if the difference between the number of the already registered prospective attendees plus the prospective attendee having 1) the at least one personal attribute data value and 2) the at least one other personal attribute data value is greater than the at least one predetermined difference limit, then: b5) Suspending, by the server, the registration of the prospective attendee to attend the social event; d) Sending, by the server, notification of registration status to the prospective attendee. The at least one personal attribute data value may comprise information about at least the sex of the prospective attendee or at least one other suitable personal attribute data value. Another method for controlling registration for a social event having features of the present invention comprises: a) Receiving a request, at a server on a network, from a group of prospective attendees to register the group of prospective attendees to attend the social event, the request comprising at least one personal attribute data value of each prospective attendee of the group of prospective attendees; b) Deciding registration status of the group of prospective attendees, by the server, comprising: b1) Determining, by the server, whether the number of already registered prospective attendees plus the group of prospective attendees having the at least one personal attribute data value will exceed a predetermined limit, wherein: if the number of the already registered prospective attendees plus the group of prospective attendees having the at least one personal attribute data value is greater than the predetermined limit, then: b2) Cancelling, by the server, registration of the group of prospective attendees to attend the social event; if the number of the already registered prospective attendees plus the group of prospective attendees having the at least one personal attribute data value is less than or equal to the predetermined limit, then: b3) Determining, by the server, whether the difference between 1) the number of already registered prospective attendees plus the group of prospective attendees having the at least one personal attribute data value is less than, equal to, or greater than a predetermined difference limit, wherein: if the difference between the number of the already registered prospective attendees plus the group of prospective attendees having 1) the at least one personal attribute data value is less than or equal to the predetermined difference limit, then: b4) Registering the group of prospective attendees, by the server, to attend the social event; if the difference between the number of the already registered prospective attendees plus the group of prospective attendees having the at least one personal attribute data value is greater than the predetermined difference limit, then: b5) Suspending, by the server, the registration of the group of prospective attendees to attend the social event; d) Sending, by the server, notification of registration status to the group of prospective attendees. The at least one personal attribute data value may comprise information about at least the sex of each of the prospective attendees of the group of prospective attendees or at least one other suitable personal attribute data value.

### DRAWINGS

These and other features, aspects, and advantages of the present invention will become better understood with regard to the following description, appended claims, and accompanying drawings where:

FIG. 1 is a schematic representation of steps of a method for controlling registration for a social event, in accordance with the present invention;

FIG. 2 is a schematic representation of steps of a method for controlling registration for a social event, based upon a personal attribute data value of a prospective attendee;

FIG. 3 is a schematic representation of steps of a method for controlling registration for a social event, based upon the sex of a prospective attendee;

FIG. 4 is a schematic representation of a graphical user interface and steps of a method that a prospective attendee may use to begin registering to attend the social event;

FIG. 5 is a schematic representation of the graphical user interface and other steps of the method continued from FIG. 4 that the prospective attendee may use to continue registering to attend the social event and pay a fee to attend the social event;

FIG. 6 is a schematic representation of the graphical user interface and other steps of the method continued from FIG. 5 that the prospective attendee may use to continue registering to attend the social event and pay the fee to attend the social event;

FIG. 7 is a schematic representation of the graphical user interface and other steps of the method continued from FIG. 6 that the prospective attendee may use to finish registering to attend the social event and pay the fee to attend the social event;

FIG. 8 is a schematic representation of a graphical user interface that an administrator may use to manage a computer software application that controls registration for the social event;

FIG. 9 is a schematic representation of steps of a method that a prospective attendee may use to register to attend the social event and a graphical user interface that may be presented to the prospective attended prior to registering and after registering to attend the social event;

FIG. 10 is a schematic representation of steps of a method for controlling registration for a social event, in accordance with the present invention, for a group of prospective attendees;

FIG. 11 is a schematic representation of a graphical user interface and other steps of a method continued from FIG. 4 that the prospective attendee may use to continue registering a group of prospective attendees to attend the social event and pay fees to attend the social event;

FIG. 12 is a schematic representation of the graphical user interface and other steps of the method continued from FIG. 11 that the prospective attendee may use to continue registering the group of prospective attendees to attend the social event and pay the fees to attend the social event; and

FIG. 13 is a schematic representation of the graphical user interface and other steps of the method continued from FIG. 12 that the prospective attendee may use to finish registering the group of prospective attendees to attend the social event and pay the fees to attend the social event.

### DESCRIPTION

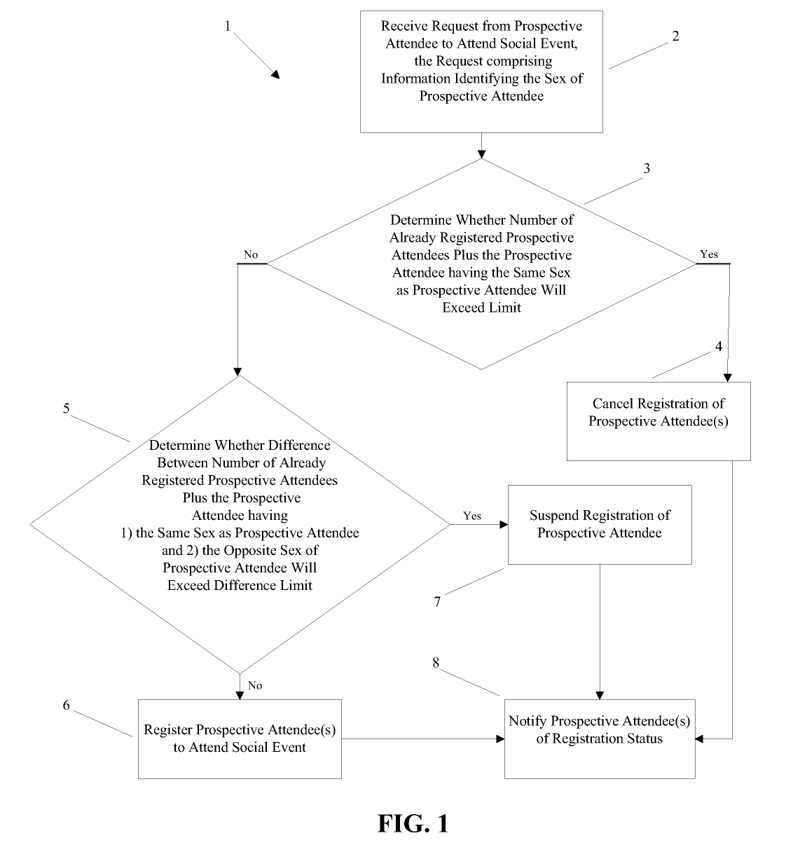

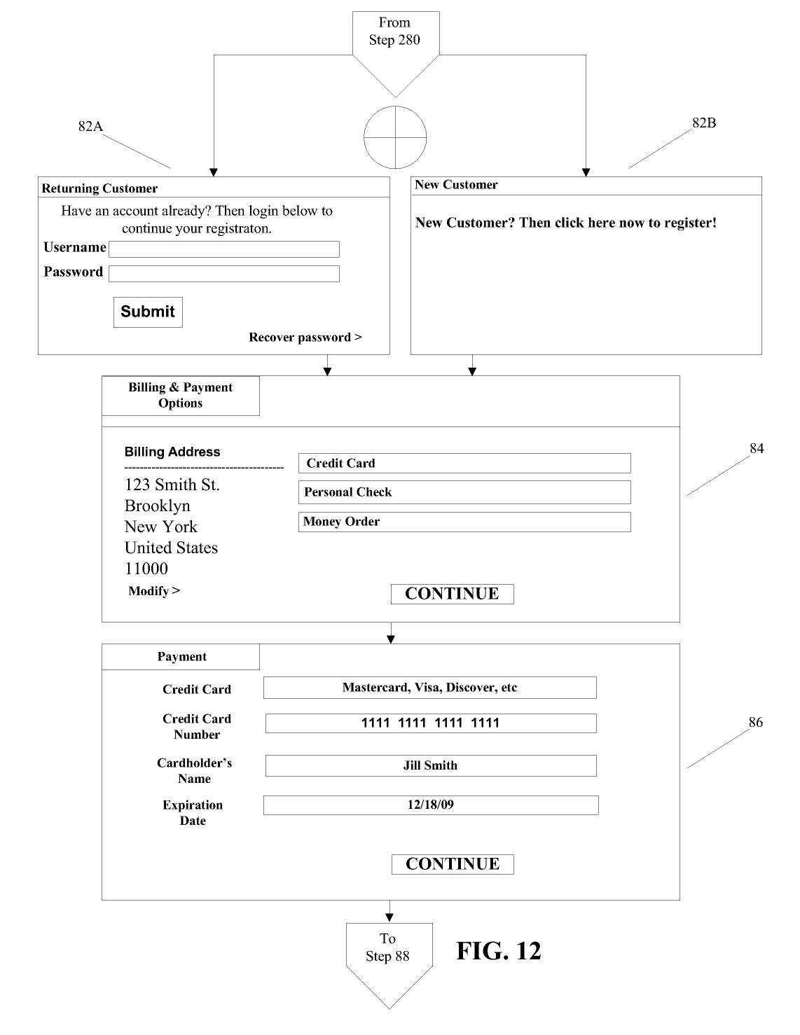

The preferred embodiments of the present invention will be described with reference to FIGS. 1-13 of the drawings. Identical elements in the various figures are identified with the same reference numbers.

FIG. 1 is a schematic representation of steps of a method or process for controlling registration for a social event 1, in accordance with the present invention, in which an applicant or prospective attendee sends a request to a system, apparatus, or computer readable storage medium to register the applicant or prospective attendee to attend the social event.

The method or process for controlling registration for the social event 1 is typically executed on a hardware device, a hardware system, hardware apparatus, or hardware computer readable storage medium, although other suitable means may be used to execute the method or process for controlling registration for the social event 1.

The “sex” of a prospective attendee may be considered to be a personal attribute data value of the prospective attendee.

In more detail, FIG. 1 is a schematic representation of steps of a method for controlling registration for a social event 1, in accordance with the present invention, comprising:
a) Receiving a request, at a server on a network, from a prospective attendee to register to attend a social event (step 2),
   the request comprising at least one personal attribute data value, which in this case is the sex of the prospective attendee;
b) Deciding registration status of the prospective attendee, by the server, comprising:
   b1) Determining, by the server, whether the number of already registered prospective attendees plus the prospective attendee having the at least one personal attribute data value, having the same sex as the prospective attendee, will exceed a predetermined limit (step 3), wherein:
      if the number of the already registered prospective attendees plus the prospective attendee having the at least one personal attribute data value is greater than the predetermined limit, then:
      b2) Cancelling, by the server, registration of the prospective attendee to attend the social event (step 4);
      if the number of the already registered prospective attendees plus the prospective attendee having the at least one personal attribute data value is less than or equal to the predetermined limit, then:
      b3) Determining, by the server, whether the difference between 1) the number of already registered prospective attendees plus the prospective attendee having the at least one personal attribute data value and 2) the at least one other personal attribute data value is less than, equal to, or greater than at least one predetermined difference limit (step 5), wherein:
         if the difference between the number of the already registered prospective attendees plus the prospective attendee having 1) the at least one personal attribute data value and 2) the at least one other personal attribute data value is less than or equal to the at least one predetermined difference limit, then:
         b4) Registering the prospective attendee, by the server, to attend the social event (step 6);
         if the difference between the number of the already registered prospective attendees plus the prospective attendee having 1) the at least one personal attribute data value and 2) the at least one other personal attribute data value is greater than the at least one predetermined difference limit, then:
         b5) Suspending, by the server, the registration of the prospective attendee to attend the social event (step 7);
d) Sending, by the server, notification of registration status to the prospective attendee (step 8).

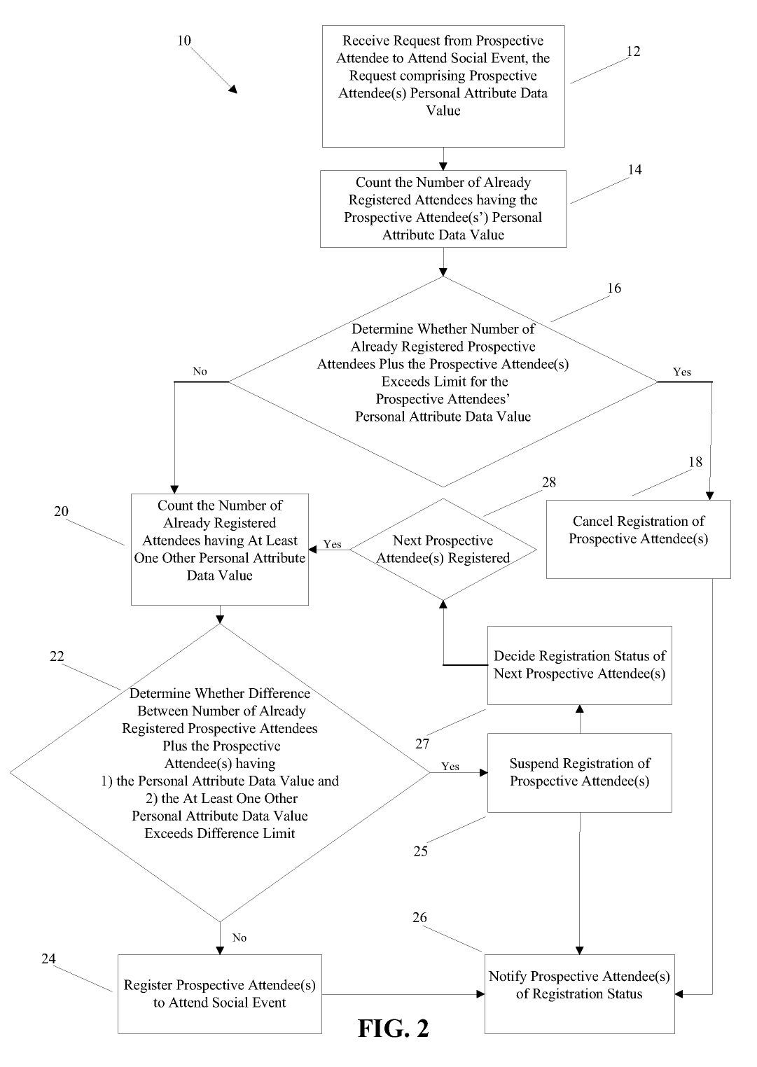

FIG. 2 is a schematic representation of steps of a method for controlling registration at a social event 10, which is substantially the same as the method for controlling registration for the social event 1, except that the method for controlling registration at the social event 10 comprises the prospective attendee's personal attribute data value and shows details of counting the number of already registered prospective attendee plus the prospective attendee.

In more detail, FIG. 2 is a schematic representation of steps of a method for controlling registration for a social event 10, in accordance with the present invention, comprising:
a) Receiving a request, at a server on a network, from a prospective attendee to register to attend a social event (step 12),
   the request comprising at least one personal attribute data value of the prospective attendee;
   b) Counting, by the server, the number of already registered prospective attendees having the at least one personal attribute data value (step 14);
   c) Deciding registration status of the prospective attendee, by the server, comprising:
   c1) Determining, by the server, whether the number of already registered prospective attendees plus the prospective attendee having the at least one personal attribute data value is less than, equal to, or greater than a predetermined limit (step 16), wherein:
      if the number of the already registered prospective attendees plus the prospective attendee having the at least one personal attribute data value is greater than the predetermined limit, then:
      c2) Cancelling, by the server, registration of the prospective attendee to attend the social event (step 18);
      if the number of the already registered prospective attendees plus the prospective attendee having the at least one personal attribute data value is less than or equal to the predetermined limit, then:
      c3) Counting, by the server, the number of already registered prospective attendees having at least one other personal attribute data value (step 20);
      c4) Determining, by the server, whether the difference between 1) the number of already registered prospective attendees plus the prospective attendee having the at least one personal attribute data value and 2) the at least one other personal attribute data value is less than, equal to, or greater than at least one predetermined difference limit (step 22), wherein:
         if the difference between the number of the already registered prospective attendees plus the prospective attendee having 1) the at least one personal attribute data value and 2) the at least one other personal attribute data value is less than or equal to the at least one predetermined difference limit, then:
         c5) Registering the prospective attendee, by the server, to attend the social event (step 24);
         if the difference between the number of the already registered prospective attendees plus the prospective attendee having 1) the at least one personal attribute data value and 2) the at least one other personal attribute data value is greater than the at least one predetermined difference limit, then:
         c6) Suspending, by the server, the registration of the prospective attendee to attend the social event (step 25);
d) Sending, by the server, notification of registration status to the prospective attendee (step 26).

FIG. 2 also shows that if the registration of the prospective attendee to attend the social event has been suspended, then the method for controlling registration for the social event 10 further comprises:
e) Deciding, by the server, the registration status of a next prospective attendee (step 27), wherein if the registration status of the next prospective attendee is registered (step 28):
   f) Deciding registration status of the prospective attendee, by the server, comprising:
      f1) Counting, by the server, the number of already registered prospective attendees, including the next prospective attendee, having the at least one other personal attribute data value (step 20);
      f2) Determining, by the server, whether the difference between the number of already registered prospective attendees, including the next prospective attendee, plus the prospective attendee having 1) the at least one personal attribute data value and 2) the at least one other personal attribute data value is less than, equal to, or greater than the at least one predetermined difference limit (step 22), wherein:
         if the difference between the number of the already registered prospective attendees, including the next prospective attendee, plus the prospective attendee having 1) the at least one personal attribute data value and 2) the at least one other personal attribute data value is less than or equal to the at least one predetermined difference limit, then:
            f3) Registering, by the server, the prospective attendee to attend the social event (step 24);
         if the difference between the number of the already registered prospective attendees, including the next prospective attendee, plus the prospective attendee having 1) the at least one personal attribute data value and 2) the at least one other personal attribute data value is greater than the at least one predetermined difference limit, then:
            f4) Suspending, by the server, the registration of the prospective attendee to attend the social event (step 25);
g) Sending, by the server, notification of registration status to the prospective attendee (step 26).

Object oriented programming and/or other software programming methods may be used to develop software applications and web based applications of the present invention. Such applications may be used on servers and/or computers on networks and distributed networks, and in particular the internet, and for prospective attendees to register for social events of all kinds.

In object oriented programming parlance, a class may be defined, for example, as a person; whereas, a particular person, such as “John Doe” may be an object of the class person. An object's personal attributes, may be, for example, John Doe's, sex, height, weight, and age. A personal attribute data value for the object John Doe's attribute “sex” may be, for example, male, whereas a personal attribute data value for an object Jane Doe's attribute “sex” may be, for example, female.

Typical personal attributes that may be used with the method of the present invention to control the registration of prospective attendees at social events, include: sex, ethnic background, age, and income, although other suitable personal attributes may be used.

Personal attribute data values may be:
“male” or “female” for the personal attribute “sex”;
“black”, “white”, “Hispanic”, “Asian” for the personal attribute “ethnic background”;
“under 25”, “25-30”, “30+”, and “40+” for the personal attribute “age”; and “15K-25K”, “26K-35K”, “26K-45K”, and “46K+” for the personal attribute “income’.

Additional personal attributes, additional personal attribute data values, and other suitable personal attributes and/or other suitable personal attribute data values may be used.

The prospective attendees may be apprised of what types of individuals are projected to attend the social event, by allowing the prospective attendees to view or be shown the personal attributes and/or personal attribute data values of all the projected attendees that are registered to attend the social event. In this way, the projected attendees may gauge their chances of success at the social event.

The above may be restated, wherein the sex of the prospective attendee is the determining factor in controlling registration of prospective attendees' registration for a social event.

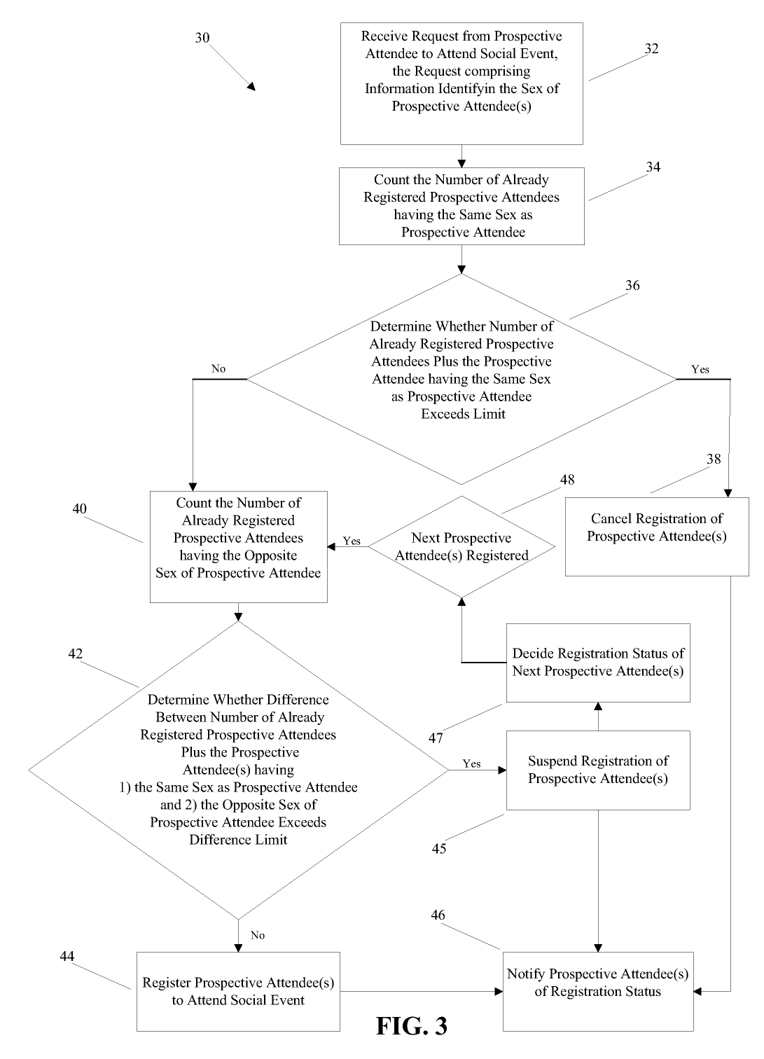

FIG. 3 is a schematic representation of steps of a method for controlling registration for a social event 30, which is substantially the same as the method for controlling registration for a social event 1, except that the method for controlling registration for a social event 30 shows details of counting the number of already registered prospective attendees plus the prospective attendee.

The steps of the method for controlling registration for a social event 30, shown in FIG. 3, based upon the sex of the prospective attendee, comprise:
a) Receiving a request, at a server on a network, from a prospective attendee to register to attend a social event (step 32),
   the request comprising information identifying the sex of the prospective attendee;
b) Counting, by the server, the number of already registered prospective attendees having the same the sex as the prospective attendee (step 34);
c) Deciding registration status of the prospective attendee, by the server, comprising:
   c1) Determining, by the server, whether the number of already registered prospective attendees plus the prospective attendee having the same sex as the prospective attendee is less than, equal to, or greater than a predetermined limit (step 36), wherein:
      if the number of the already registered prospective attendees plus the prospective attendee having the same sex as the prospective attendee is greater than the predetermined limit, then:
      c2) Cancelling, by the server, registration of the prospective attendee to attend the social event (step 38);
      if the number of the already registered prospective attendees plus the prospective attendee having the same sex as the prospective attendee is less than or equal to the predetermined limit, then:
      c3) Counting, by the server, the number of already registered prospective attendees having the opposite sex of the prospective attendee (step 40);
      c4) Determining, by the server, whether the difference between 1) the number of already registered prospective attendees plus the prospective attendee having the same sex as the prospective attendee and 2) the opposite sex of the prospective attendee is less than, equal to, or greater than at least one predetermined difference limit (step 42), wherein:
         if the difference between the number of the already registered prospective attendees plus the prospective attendee having 1) the same sex as the prospective attendee and 2) the opposite sex of the prospective attendee is less than or equal to the at least one predetermined difference limit, then:
         c5) Registering the prospective attendee, by the server, to attend the social event (step 44);
         if the difference between the number of the already registered prospective attendees plus the prospective attendee having 1) the same sex as the prospective attendee and 2) the opposite sex of the prospective attendee is greater than the at least one predetermined difference limit, then:
         c6) Suspending, by the server, the registration of the prospective attendee to attend the social event (step 45);
d) Sending, by the server, notification of registration status to the prospective attendee (step 46).

FIG. 3 also shows that if the registration of the prospective attendee to attend the social event has been suspended, then the method for controlling registration for the social event 30, further comprises:
e) Deciding, by the server, the registration status of a next prospective attendee (step 47), wherein if the registration status of the next prospective attendee is registered (step 48):
   f) Deciding registration status of the prospective attendee, by the server, comprising:
      f1) Counting, by the server, the number of already registered prospective attendees, including the next prospective attendee, having the opposite sex of the prospective attendee (step 40);
      f2) Determining, by the server, whether the difference between the number of already registered prospective attendees, including the next prospective attendee, plus the prospective attendee having 1) the same sex as the prospective attendee and 2) the opposite sex of the prospective attendee is less than, equal to, or greater than the at least one predetermined difference limit (step 42), wherein:
         if the difference between the number of the already registered prospective attendees, including the next prospective attendee, plus the prospective attendee having 1) the same sex as the prospective attendee and 2) the opposite sex of the prospective attendee is less than or equal to the at least one predetermined difference limit, then:
            f3) Registering, by the server, the prospective attendee to attend the social event (step 44);
         if the difference between the number of the already registered prospective attendees, including the next prospective attendee, plus the prospective attendee having 1) the same sex as the prospective attendee and 2) the opposite sex of the prospective attendee is greater than the at least one predetermined difference limit, then:
            f4) Suspending, by the server, the registration of the prospective attendee to attend the social event (step 45);
g) Sending, by the server, notification of registration status to the prospective attendee (step 46).

The system or method for controlling registration for the social event is typically performed on a distributed network, such as the internet, wherein the prospective attendee and the already registered prospective attendees register or have already registered to attend the social event, using a client device, computer, such as a personal computer, laptop, or PDA, or other suitable device having a graphical user interface, such as a web browser or other suitable interface, to contact a server device and transmit information, such as the aforementioned personal attribute data values, for the server device to make a decision as to whether or not the prospective attendee should be registered to attend the social event, based upon the received information, and transmit registration status to the prospective attendee. The registration status is typically sent to the prospective attendee via electronic mail or to the prospective attendee's web browser, graphical user interface, or other suitable interface at the prospective attendee's client device, computer, or other suitable device.

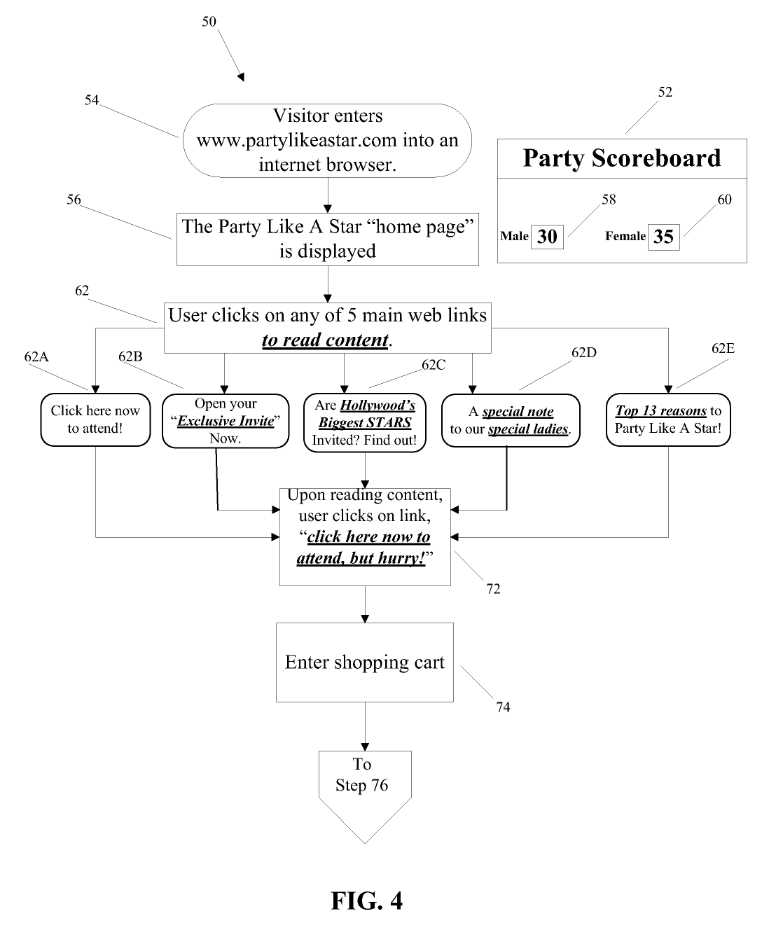

FIGS. 4-7 show a typical graphical user interface, showing typical steps of a method 50, which the prospective attendee may use to register for the social event, and typical appearance of the graphical user interface during the steps of the method 50, although other suitable user interfaces and or methods may be used by the prospective attendees to register for the social event. The appearance of the graphical user interface is shown at each of the steps of the method 50.

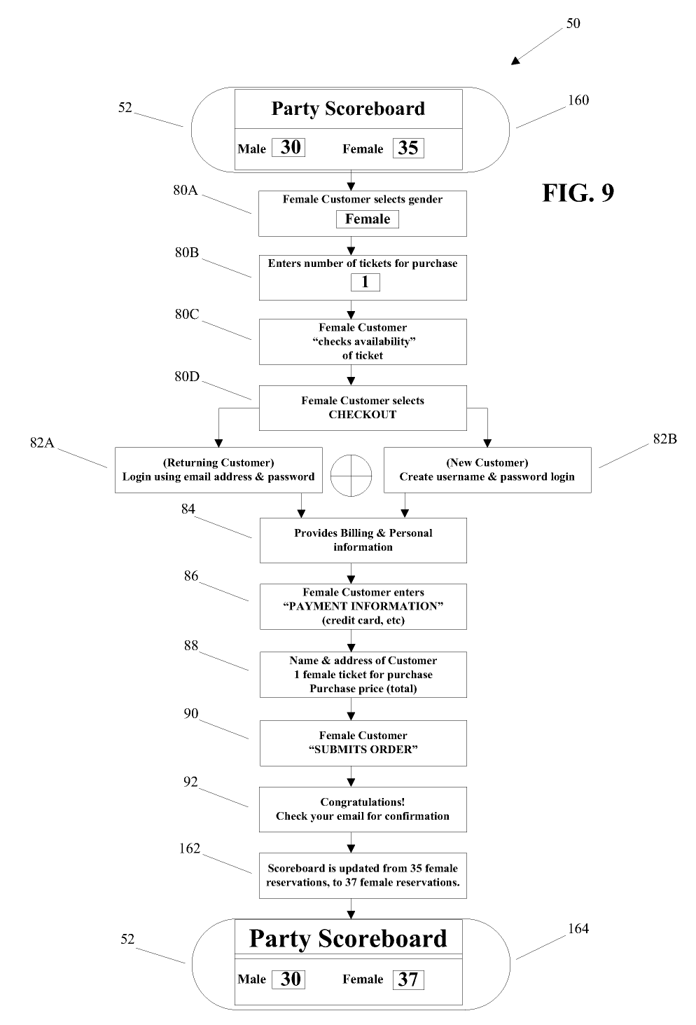

FIGS. 4 and 9 show a unique aspect of the system and method for controlling registration for the social event that includes a scoreboard 52, which displays current status of projected attendance at the social event. The scoreboard 52 is typically displayed to all prospective attendees prior to, during, and after registration to attend the social event, so that the prospective attendee may gauge his or her chances of success at the social event. The scoreboard 52 may alternatively be used only by an individual managing the social event.

The scoreboard 52 may be used to apprise the prospective attendees of the types of individuals that are projected to attend the social event, by allowing the prospective attendees to view or be shown the personal attributes and/or personal attribute data values of all the projected attendees that are registered to attend the social event. In this way, the projected attendees may gauge their projected chances of success at the social event.

The scoreboard 52 shows a typical example of how many males and females are projected to attend the social event, information that is most often very desirable to the prospective attendees in determining whether they are interested in attending the social event and gauging their projected success.

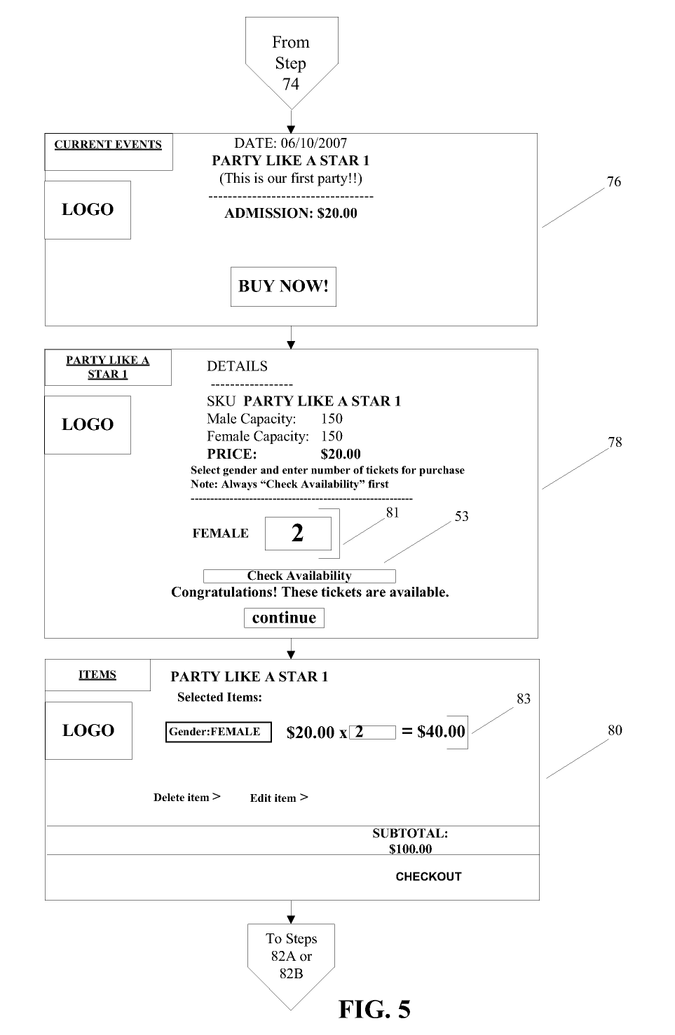

A prospective attendee may also check ticket availability for attending a social event by viewing check availability box 53, as shown in FIG. 5.

In more detail, as shown in FIGS. 4-7, a prospective attendee or visitor may enter a web site address or url into his or her web browser or other suitable user interface of a client device, computer, or other suitable device at step 54 of the method 50, which the prospective attendee may use to register for the social event. A home page is displayed at step 56 of the method, and the scoreboard 52 is displayed, which shows the number of already registered prospective male attendees 58 and the number of already registered prospective female attendees 60.

The prospective attendee may select typical options at step 62, which include clicking to attend or register for the social event 62A, opening an exclusive invitation 62B, determining if any well known stars have been invited to attend the social event 62C, a special note 62D, reasons why the prospective attendee should be interested in attending the social event 62E, or other suitable options, and which lead to selecting and clicking to attend the social event at step 72, after which a shopping cart is entered at step 74, which provides the prospective attendee with information about the social event or events at step 76, shown in FIG. 5, details of the social event or events at step 78, gender selection, number of tickets, cost to attend one or more of the social events by one or more prospective attendees, and checkout at step 80, which is shown later in more detail as steps 80A, 80B, 80C, and 80D.

The typical graphical user interface is shown having ticket request box 81 at step 78 and fee calculation box 83 at step 80, each of which are shown in FIG. 5.

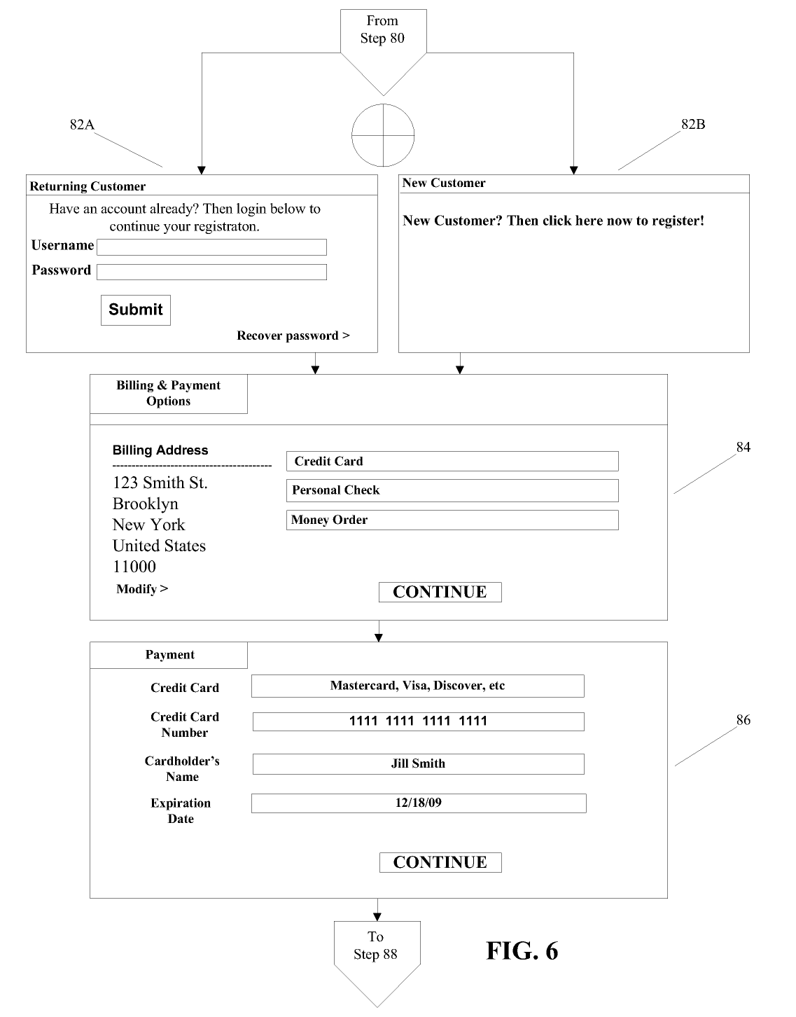

The prospective attendee enters whether he or she is a returning customer at step 82A or a new customer at step 82B, provides personal information and/or billing information at step 84, and payment information at step 86, each of which are shown in FIG. 6.

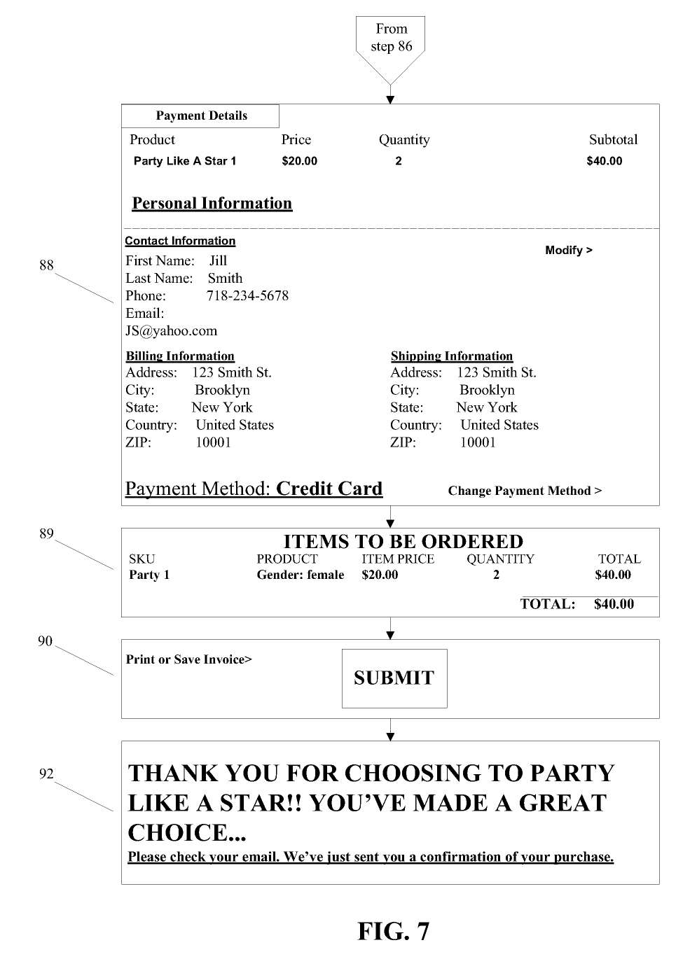

The prospective attendee confirms personal information and payment details at step 88, shown in FIG. 7. The typical graphical user interface is shown having order box 89 for items to be ordered, as shown in FIG. 7.

The order is submitted at step 90, and a greeting is displayed at step 92, as shown in FIG. 7, confirming the prospective attendee's payment and informing the prospective attendee to check his or her e-mail for further information, such as registration status and/or other information regarding the social event.

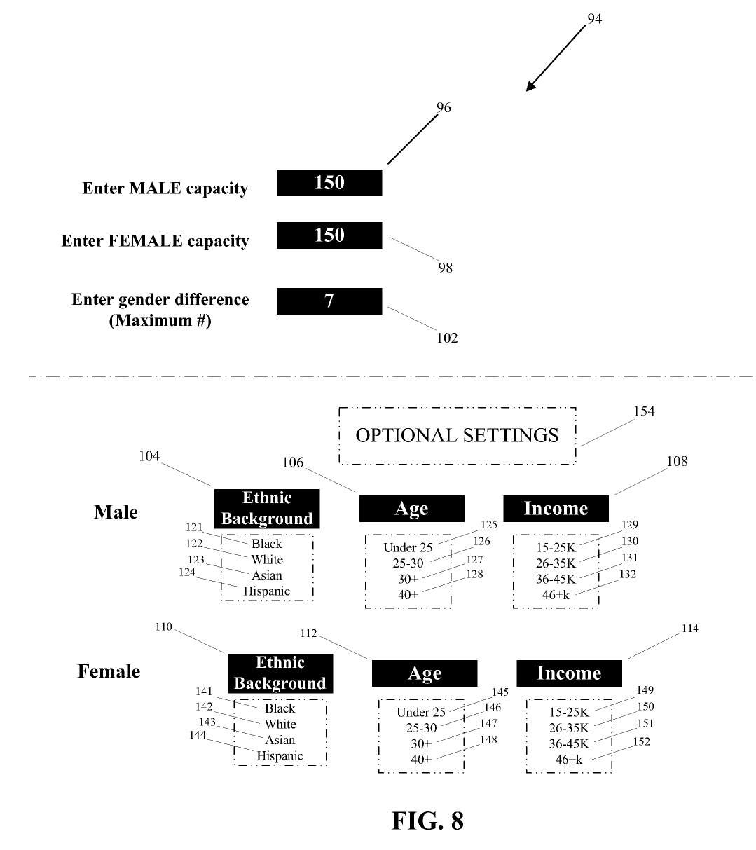

FIG. 8 shows a graphical user interface 94 that an administrator may use to manage a computer software application that controls registration for the social event, showing male capacity 96 of the social event, female capacity 98 of the social event, and gender difference 102 to be applied to the event, or, for example, how many more prospective females than prospective males are projected to attend the social event, or vice versa.

Male personal attributes, such as ethnic background 104, age 106, and income level 108 are shown. Female personal attributes, such as ethnic background 110, age 112, and income level 114 are also shown. Male personal attribute data values 121-132 are shown for the male personal attributes ethnic background 104, age 106, and income level 108. Female personal attribute data values 141-152 are shown for female personal attributes ethnic background 110, age 112, and income level 114. Other suitable personal attributes and/or personal attributed data values may be used. Optional settings 154 are also shown.

Now, in more detail, features of the method for controlling registration for a social event 10, shown in FIG. 2, and the method for controlling registration for a social event 30, shown in FIG. 3, include online systems and methods, that may be used to control the exact amount of men and women, who can attend a social event. The method for controlling registration for a social event 10 may be used to ensure that the number of prospective attendees who are projected to attend a social event will be the same. Alternatively, the method for controlling registration for a social event 10 may be used to change the balance of prospective attendees for other social reasons.

The scoreboard 52, shown in FIG. 4, which displays the number of males and females that are projected to attend the social event is typically displayed on the system's website, is built into the website's shopping cart system, and is updated in real time.

The method for controlling registration for a social event 10, shown in FIG. 2, and the method for controlling registration for a social event 30, shown in FIG. 3, also include means for suspending registration of a prospective attendee if the difference between 1) the number of prospective attendees plus the prospective attendee having at least one personal attribute, such as having the male attribute data value, and 2) the number of prospective attendees having at least one other personal attribute, such as the female attribute data value are greater than a predetermined difference limit. The predetermined difference limit may be greater than, equal to, or less than zero.

FIG. 9 shows additional details of typical steps of the method 50 that the prospective attendee may use to register, submit the prospective attendee's request to attend the social event, pay the fee to attend the social event, and, in particular, the scoreboard 52 that may be used to display the number of prospective male and female attendees that may attend the social event.

FIG. 9 shows the scoreboard 52 prior to the prospective attendee registering for the social event at 160 and the scoreboard 52 after the prospective attendee registers for the social event at 164.

Now, in more detail, as shown in FIG. 9, the prospective female attendee selects her gender at step 80A and the number of tickets for one or more prospective attendees to attend one or more of the social events at step 80B. The prospective attendee checks ticket availability by clicking on the check availability box 53 of FIG. 5 at step 80C of FIG. 9. The prospective female attendee selects check out at step 80D.

Again, as previously discussed, the prospective attendee enters whether he or she is a returning customer at step 82A or a new customer at step 82B, provides personal information and/or billing information at step 84, and payment information at step 86, confirms personal information and payment details at step 88. The order is submitted at 90, and a greeting is displayed at step 92, confirming the prospective attendee's payment and informing the prospective attendee to check his or her e-mail for further information, such as registration status and/or other information regarding the social event, as previously shown in FIGS. 4-7.

FIG. 9 also shows the scoreboard 52 being updated at step 162, after the order is submitted at 90.

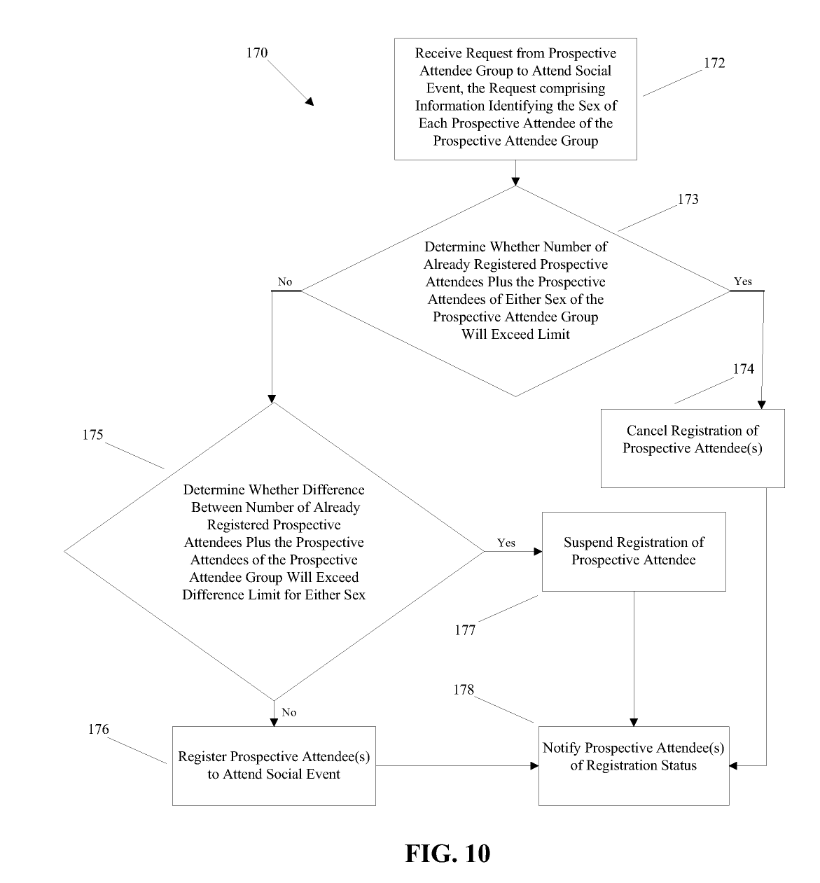

FIG. 10 is a schematic representation of steps of a method or process for controlling registration for a social event 170, which is substantially the same as the method for controlling registration for a social event 1, except that the method for controlling registration for a social event 170 may be used to control registration of a group of prospective attendees or individuals desiring to attend a social event.

In more detail, FIG. 10 is a schematic representation of steps of a method for controlling registration for a social event 170, in accordance with the present invention, comprising:
a) Receiving a request, at a server on a network, from a group of prospective attendees to register the group of prospective attendees to attend the social event (step 172),
   the request comprising at least one personal attribute data value of each prospective attendee of the group of prospective attendees, which in this case is information about at least the sex of each prospective attendee of the group of prospective attendees;
b) Deciding registration status of the group of prospective attendees, by the server, comprising:
   b1) Determining, by the server, whether the number of already registered prospective attendees plus the group of prospective attendees having the at least one personal attribute data value will exceed a predetermined limit (step 173), wherein:
      if the number of the already registered prospective attendees plus the group of prospective attendees having the at least one personal attribute data value is greater than the predetermined limit, then:
      b2) Cancelling, by the server, registration of the group of prospective attendees to attend the social event (step 174);
      if the number of the already registered prospective attendees plus the group of prospective attendees having the at least one personal attribute data value is less than or equal to the predetermined limit, then:
      b3) Determining, by the server, whether the difference between 1) the number of already registered prospective attendees plus the group of prospective attendees having the at least one personal attribute data value is less than, equal to, or greater than a predetermined difference limit (step 175), wherein:
         if the difference between the number of the already registered prospective attendees plus the group of prospective attendees having 1) the at least one personal attribute data value is less than or equal to the predetermined difference limit, then:
         b4) Registering the group of prospective attendees, by the server, to attend the social event (step 176);
         if the difference between the number of the already registered prospective attendees plus the group of prospective attendees having the at least one personal attribute data value is greater than the predetermined difference limit, then:
         b5) Suspending, by the server, the registration of the group of prospective attendees to attend the social event (step 177);
d) Sending, by the server, notification of registration status to the group of prospective attendees (step 178).

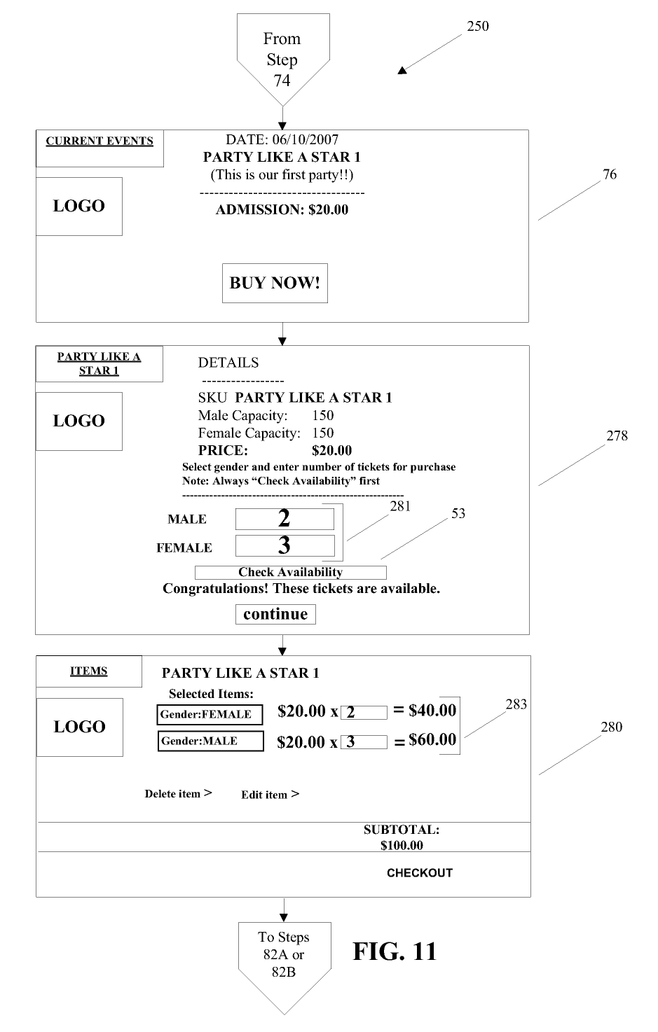

FIGS. 11-13 show a typical graphical user interface and typical steps of a method 250 continued from FIG. 4, which are substantially the same as the typical graphical user interface and the typical steps 76 through 92 of the method 50 of FIGS. 5-7, except that the typical graphical user interface and the typical steps of the method 250 of FIGS. 11-13 show the typical graphical user interface and the typical steps of the method 250 for registering a group of prospective attendees to attend the social event.

In more detail, the typical graphical user interface of FIGS. 11-13, and in particular FIG. 11, is shown having ticket request boxes 281 at step 278 and fee calculation boxes 283 at step 280 for registering the group of prospective attendees to attend the social event.

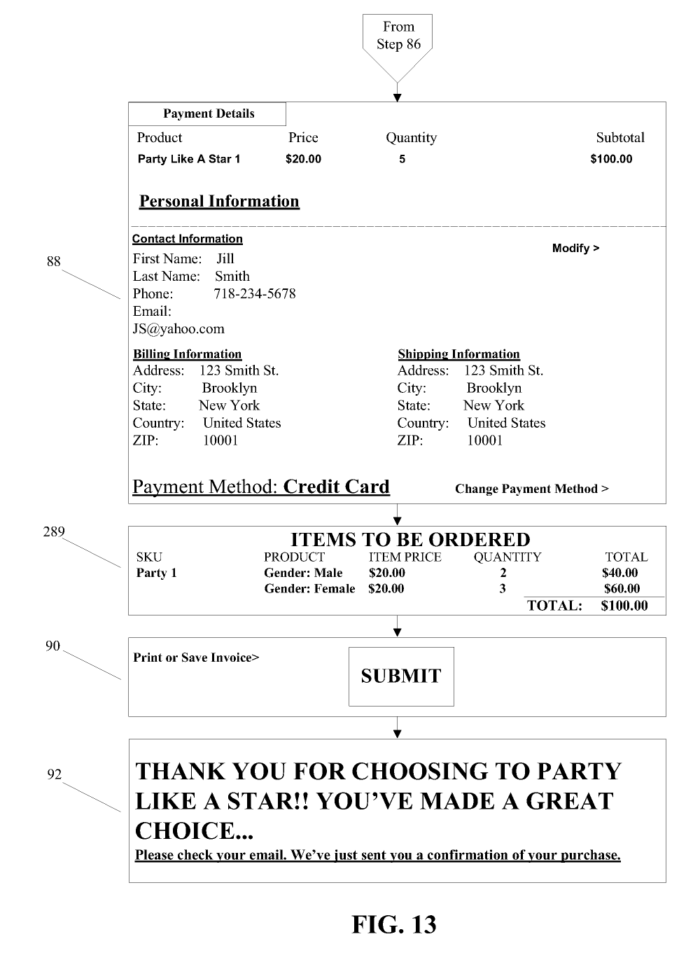

In further detail, the typical graphical user interface of FIGS. 11-13, and in particular FIG. 13, is shown having order box 289 for items to be ordered for registering the group of prospective attendees to attend the social event.

Again, typically, to attend a social event, male and/or female prospective attendees and/or groups of prospective attendees may choose the social event that they would like to attend from a list of social events, select their own gender, as one of two distinct options, enter personal information, pay a fee, as required, and check out to complete registration.

It should be noted that all personal information is typically kept confidential, so that prospective attendees do not know personal information of any other prospective attendees, until they meet at the social event, until they themselves disclose it to other prospective interested parties, as they desire or not desire to do.

The online system and method may, thus, be used to control the number of prospective male attendees and the number of prospective female attendees who may attend a event, and ensure proper balance between males and females to maximize success of the social event for both males and females alike, although other suitable attributes of the prospective attendees may be used.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method for controlling registration for a social event, comprising:
a) Receiving a request, at a server on a network, from a prospective attendee to register to attend said social event,
said request comprising at least one personal attribute data value of said prospective attendee;
b) Deciding registration status of said prospective attendee, by said server, comprising:
b1) Determining, by said server, whether the number of already registered prospective attendees plus said prospective attendee having said at least one personal attribute data value, will exceed a predetermined limit, wherein:
if the number of the already registered prospective attendees plus said prospective attendee having said at least one personal attribute data value is greater than said predetermined limit, then:
b2) Cancelling, by said server, registration of said prospective attendee to attend said social event;
if said number of said already registered prospective attendees plus said prospective attendee having said at least one personal attribute data value is less than or equal to said predetermined limit, then:
b3) Determining, by said server, whether the difference between 1) said number of already registered prospective attendees plus said prospective attendee having said at least one personal attribute data value and 2) at least one other personal attribute data value is less than, equal to, or greater than at least one predetermined difference limit, wherein:
if said difference between said number of said already registered prospective attendees plus said prospective attendee having 1) said at least one personal attribute data value and 2) said at least one other personal attribute data value is less than or equal to said at least one predetermined difference limit, then:
b4) Registering said prospective attendee, by said server, to attend said social event;
if said difference between said number of said already registered prospective attendees plus said prospective attendee having 1) said at least one personal attribute data value and 2) said at least one other personal attribute data value is greater than said at least one predetermined difference limit, then:
b5) Suspending, by said server, said registration of said prospective attendee to attend said social event;
d) Sending, by said server, notification of registration status to said prospective attendee.

2. The method according to claim 1, wherein said at least one personal attribute data value comprises information about at least the sex of said prospective attendee and said at least one personal attribute data value is from the group consisting of male and female.

3. A method for controlling registration for a social event, comprising:
a) Receiving a request, at a server on a network, from a group of prospective attendees to register said group of prospective attendees to attend said social event,
said request comprising at least one personal attribute data value of each prospective attendee of said group of prospective attendees;
b) Deciding registration status of said group of prospective attendees, by said server, comprising:
b1) Determining, by said server, whether the number of already registered prospective attendees plus said group of prospective attendees having said at least one personal attribute data value will exceed a predetermined limit, wherein:
if said number of said already registered prospective attendees plus said group of prospective attendees having said at least one personal attribute data value is greater than said predetermined limit, then:
b2) Cancelling, by said server, registration of said group of prospective attendees to attend said social event;
if said number of said already registered prospective attendees plus said group of prospective attendees having said at least one personal attribute data value is less than or equal to said predetermined limit, then:
b3) Determining, by said server, whether the difference between 1) said number of already registered prospective attendees plus said group of prospective attendees having said at least one personal attribute data value is less than, equal to, or greater than a predetermined difference limit, wherein:
if said difference between said number of said already registered prospective attendees plus said group of prospective attendees having 1) said at least one personal attribute data value is less than or equal to said predetermined difference limit, then:
b4) Registering said group of prospective attendees, by said server, to attend said social event;
if said difference between said number of said already registered prospective attendees plus said group of prospective attendees having said at least one personal attribute data value is greater than said predetermined difference limit, then:
b5) Suspending, by said server, said registration of said group of prospective attendees to attend said social event;
d) Sending, by said server, notification of registration status to said group of prospective attendees.

4. The method according to claim 3, wherein said at least one personal attribute data value comprises information about at least the sex of each said prospective attendee of said group of prospective attendees and said at least one personal attribute data value is from the group consisting of male and female.

5. A method for controlling registration for a social event, comprising:
a) Receiving a request, at a server on a network, from a prospective attendee to register to attend said social event,
said request comprising at least one personal attribute data value of said prospective attendee;
b) Counting, by said server, the number of already registered prospective attendees having said at least one personal attribute data value;
c) Deciding registration status of said prospective attendee, by said server, comprising:
c1) Determining, by said server, whether said number of already registered prospective attendees plus said prospective attendee having said at least one personal attribute data value is less than, equal to, or greater than a predetermined limit, wherein:
if said number of said already registered prospective attendees plus said prospective attendee having said at least one personal attribute data value is greater than said predetermined limit, then:
c2) Cancelling, by said server, registration of said prospective attendee to attend said social event;
if said number of said already registered prospective attendees plus said prospective attendee having said at least one personal attribute data value is less than or equal to said predetermined limit, then:
c3) Counting, by said server, the number of already registered prospective attendees having at least one other personal attribute data value;
c4) Determining, by said server, whether the difference between 1) said number of already registered prospective attendees plus said prospective attendee having said at least one personal attribute data value and 2) said at least one other personal attribute data value is less than, equal to, or greater than at least one predetermined difference limit, wherein:
if said difference between said number of said already registered prospective attendees plus said prospective attendee having 1) said at least one personal attribute data value and 2) said at least one other personal attribute data value is less than or equal to said at least one predetermined difference limit, then:
c5) Registering said prospective attendee, by said server, to attend said social event;
if said difference between said number of said already registered prospective attendees plus said prospective attendee having 1) said at least one personal attribute data value and 2) said at least one other personal attribute data value is greater than said at least one predetermined difference limit, then:
c6) Suspending, by said server, said registration of said prospective attendee to attend said social event;
d) Sending, by said server, notification of registration status to said prospective attendee.

6. The method according to claim 5, wherein: if said registration of said prospective attendee to attend said social event has been suspended:
e) Deciding, by said server, said registration status of a next prospective attendee, wherein if said registration status of said next prospective attendee is registered:
f) Deciding registration status of said prospective attendee, by said server, comprising:
f1) Counting, by said server, the number of already registered prospective attendees, including said next prospective attendee, having said at least one other personal attribute data value;
f2) Determining, by said server, whether the difference between said number of already registered prospective attendees, including said next prospective attendee, plus said prospective attendee having 1) said at least one personal attribute data value and 2) said at least one other personal attribute data value is less than, equal to, or greater than said at least one predetermined difference limit, wherein:
if said difference between said number of said already registered prospective attendees, including said next prospective attendee, plus said prospective attendee having 1) said at least one personal attribute data value and 2) said at least one other personal attribute data value is less than or equal to said at least one predetermined difference limit, then:
f3) Registering, by said server, said prospective attendee to attend said social event;
if said difference between said number of said already registered prospective attendees, including said next prospective attendee, plus said prospective attendee having 1) said at least one personal attribute data value and 2) said at least one other personal attribute data value is greater than said at least one predetermined difference limit, then:
f4) Suspending, by said server, said registration of said prospective attendee to attend said social event;
g) Sending, by said server, notification of registration status to said prospective attendee.

7. The method according to claim 5, wherein said at least one predetermined difference limit is a value from the group consisting of: zero, greater than zero, and less than zero.

8. The method according to claim 5, wherein said at least one personal attribute data value specifies the value of at least one personal attribute of said prospective attendee.

9. The method according to claim 8, wherein said at least one personal attribute comprises information about at least the sex of said prospective attendee and said at least one personal attribute data value is from the group consisting of male and female.

10. The method according to claim 9, wherein said at least one predetermined limit is the same for said personal attribute data value equal to said male and said personal attribute data value equal to said female.

11. The method according to claim 9, wherein said at least one predetermined limit comprises at least two predetermined limits, which are different for said personal attribute data value equal to said male and said personal attribute data value equal to said female.

12. The method according to claim 8, wherein said at least one personal attribute comprises at least the age of said prospective attendee and said at least one personal attribute data value is from the group consisting of a first age group and a second age group.

13. The method according to claim 8, wherein said at least one personal attribute comprises at least the race of said prospective attendee and said at least one personal attribute data value is from the group consisting of a first racial group and a second racial group.

14. The method according to claim 8, wherein said at least one personal attribute comprises at least the salary of said prospective attendee and said at least one personal attribute data value is from the group consisting of a first salary range and a second salary range.

15. The method according to claim 8, wherein said at least one other personal attribute comprises information about at least the sex of said already registered prospective attendees and said at least one personal attribute data value is from the group consisting of male and female.

16. The method according to claim 9, wherein said at least one other personal attribute comprises information about at least the sex of said already registered prospective attendees and said at least one personal attribute data value is from the group consisting of male and female.

17. The method according to claim 5, further comprising the step of informing said prospective attendee of said at least one other personal data attribute data value of said already registered projected attendees.

18. A method for controlling registration for a social event, comprising:
a) Receiving a request, at a server on a network, from a prospective attendee to register to attend said social event,
said request comprising information identifying the sex of said prospective attendee;
b) Counting, by said server, the number of already registered prospective attendees having the same said sex as said prospective attendee;
c) Deciding registration status of said prospective attendee, by said server, comprising:
c1) Determining, by said server, whether said number of already registered prospective attendees plus said prospective attendee having said same sex as said prospective attendee is less than, equal to, or greater than a predetermined limit, wherein:
if said number of said already registered prospective attendees plus said prospective attendee having said same sex as said prospective attendee is greater than said predetermined limit, then:
c2) Cancelling, by said server, registration of said prospective attendee to attend said social event;
if said number of said already registered prospective attendees plus said prospective attendee having said same sex as said prospective attendee is less than or equal to said predetermined limit, then:
c3) Counting, by said server, the number of already registered prospective attendees having the opposite sex of said prospective attendee;
c4) Determining, by said server, whether the difference between 1) said number of already registered prospective attendees plus said prospective attendee having said same sex as said prospective attendee and 2) said opposite sex of said prospective attendee is less than, equal to, or greater than at least one predetermined difference limit, wherein:
if said difference between said number of said already registered prospective attendees plus said prospective attendee having 1) said same sex as said prospective attendee and 2) said opposite sex of said prospective attendee is less than or equal to said at least one predetermined difference limit, then:
c5) Registering said prospective attendee, by said server, to attend said social event;
if said difference between said number of said already registered prospective attendees plus said prospective attendee having 1) said same sex as said prospective attendee and 2) said opposite sex of said prospective attendee is greater than said at least one predetermined difference limit, then:
c6) Suspending, by said server, said registration of said prospective attendee to attend said social event;
d) Sending, by said server, notification of registration status to said prospective attendee.

19. The method according to claim 18, wherein: if said registration of said prospective attendee to attend said social event has been suspended:
e) Deciding, by said server, said registration status of a next prospective attendee, wherein if said registration status of said next prospective attendee is registered:
f) Deciding registration status of said prospective attendee, by said server, comprising:
f1) Counting, by said server, the number of already registered prospective attendees, including said next prospective attendee, having said opposite sex of said prospective attendee;
f2) Determining, by said server, whether the difference between said number of already registered prospective attendees, including said next prospective attendee, plus said prospective attendee having 1) said same sex as said prospective attendee and 2) said opposite sex of said prospective attendee is less than, equal to, or greater than said at least one predetermined difference limit, wherein:
if said difference between said number of said already registered prospective attendees, including said next prospective attendee, plus said prospective attendee having 1) said same sex as said prospective attendee and 2) said opposite sex of said prospective attendee is less than or equal to said at least one predetermined difference limit, then:
f3) Registering, by said server, said prospective attendee to attend said social event;
if said difference between said number of said already registered prospective attendees, including said next prospective attendee, plus said prospective attendee having 1) said same sex as said prospective attendee and 2) said opposite sex of said prospective attendee is greater than said at least one predetermined difference limit, then:
f4) Suspending, by said server, said registration of said prospective attendee to attend said social event;
g) Sending, by said server, notification of registration status to said prospective attendee.

20. The method according to claim 18, wherein said at least one predetermined difference limit is a value from the group consisting of: zero, greater than zero, and less than zero.

21. The method according to claim 18, further comprising the step of informing said prospective attendee of said sex of said already registered projected attendees.

22. The method according to claim 18, wherein said prospective attendee has at least one personal attribute data value and said already registered prospective attendees have at least one other personal attribute data value.

23. The method according to claim 18, wherein said at least one personal data attribute value comprises at least the age of said prospective attendee and said at least one personal attribute data value is from the group consisting of a first age group and a second age group.

24. The method according to claim 18, wherein said at least one personal attribute data value comprises at least the salary of said prospective attendee and said at least one personal attribute data value is from the group consisting of a first salary range and a second salary range.
